(19) United States
(12) Patent Application Publication
(10) Pub. No.: US 2026/0275681 A1
(43) Pub. Date: Sep. 17, 2026

(54) SYSTEM, METHOD, AND RECORDING MEDIUM FOR CONTROLLING WORK MACHINE

(71) Applicant: KOMATSU LTD., Tokyo (JP)

(72) Inventor: Shinya HINO, Tokyo (JP)

(73) Assignee: KOMATSU LTD., Tokyo (JP)

(21) Appl. No.: 19/168,327

(22) PCT Filed: Mar. 28, 2024
(86) PCT No.: PCT/JP2024/012591

§ 371 Date: Sep. 24, 2025

(30) Foreign Application Priority Data
Mar. 28, 2023 (JP) 2023-050981

(51) Int. Cl. E02F 9/12; E02F 3/32; E02F 9/20; E02F 9/22; E02F 9/24; E02F 9/26

(52) U.S. Cl. CPC E02F 9/123; E02F 9/2033; E02F 9/24; E02F 9/262; E02F 3/32; E02F 9/2203

(57) ABSTRACT

A control system controls a work machine including a work implement to which a work tool is attachable at a tip end. The control system includes a processor. The processor identifies a virtual wall, which is a surface that prohibits entry of the work implement. The processor determines a revolution angular velocity of the work machine such that the virtual wall does not come into contact with the work machine. The processor varies the revolution angular velocity, depending on a main body weight of the work tool.

### TECHNICAL FIELD

The present disclosure relates to a system, a method, and a program.

The present application claims priority based on Japanese Patent Application No. 2023-050981, filed Mar. 28, 2023, the content of which is incorporated herein by reference.

### BACKGROUND ART

There is a known technique for setting virtual walls in a space in order to limit the operating range of a work machine. A control device for the work machine can control the work machine such that it does not exceed the virtual wall by limiting the amount of movement of an actuator of the work machine in accordance with the distance between the virtual wall and the work machine.

Furthermore, Patent Document 1 discloses a technique for preventing a work tool from departing from the work area in consideration of the inertia moment that changes depending on the posture of a work implement.

### CITATION LIST

### Patent Literature

Patent Document 1: JP 2020-143449 A

### SUMMARY OF INVENTION

### Technical Problem

Some work machines are capable of attaching various work tools to the tip end of the work implement. However, in the related art, changing of the work tool is not taken into consideration, and therefore there is a likelihood that the control for preventing the virtual wall from being crossed will not function properly when the work tool is changed.

An object of the present disclosure is to provide a system, a method, and a program that can limit the operation of a work machine such that a work tool does not enter a virtual wall, regardless of the work tool that is attached.

### Solution to Problem

According to a first aspect of the present disclosure, a system controls a work machine including a work implement to which a work tool is attachable at a tip end. The control system includes a processor. The processor identifies a virtual wall, which is a surface that prohibits entry of the work implement. The processor determines a revolution angular velocity of the work machine such that the virtual wall does not come into contact with the work machine. The processor varies the revolution angular velocity, depending on a main body weight of the work tool.

According to a second aspect of the present disclosure, a method is a control method for a work machine including a work implement to which a work tool is attachable at a tip end. The control method includes a virtual wall identification step and an angular velocity determination step. In the virtual wall identification step, a virtual wall, which is a surface that prohibits entry of the work implement, is identified. In the angular velocity determination step, a revolution angular velocity of the work machine is determined such that the virtual wall does not come into contact with the work machine. In the angular velocity determination step, the revolution angular velocity is varied depending on a main body weight of the work tool.

According to a third aspect of the present invention, a program causes a computer that controls a work machine including a work implement to which a work tool is attachable at a tip end to execute a virtual wall identification step and an angular velocity determination step. In the virtual wall identification step, a virtual wall, which is a surface that prohibits entry of the work implement, is identified. In the angular velocity determination step, a revolution angular velocity of the work machine is identified such that the virtual wall does not come into contact with the work machine. In the angular velocity determination step, the revolution angular velocity is varied depending on a main body weight of the work tool.

### Advantageous Effects of Invention

According to the above aspects, it is possible to limit the operation of a work machine such that a work tool does not enter a virtual wall, regardless of the work tool that is attached.

### BRIEF DESCRIPTION OF DRAWINGS

FIG. 1 is a schematic diagram illustrating a configuration of a work machine according to a first embodiment.

FIG. 2 is a diagram illustrating a drive system of the work machine according to the first embodiment.

FIG. 3 is a schematic block diagram illustrating a configuration of a control device according to the first embodiment.

FIG. 4 is a diagram illustrating an example of resetting of the virtual wall in association with the revolution of a revolving body in the first embodiment.

FIG. 5 is a flowchart (part 1) showing update and intervention control of the virtual wall set in the first embodiment.

FIG. 6 is a flowchart (part 2) showing update and intervention control of the virtual wall set in the first embodiment.

FIG. 7 is a diagram illustrating a configuration of a work system according to another embodiment.

### DESCRIPTION OF EMBODIMENTS

### First Embodiment

### Configuration of Work Machine

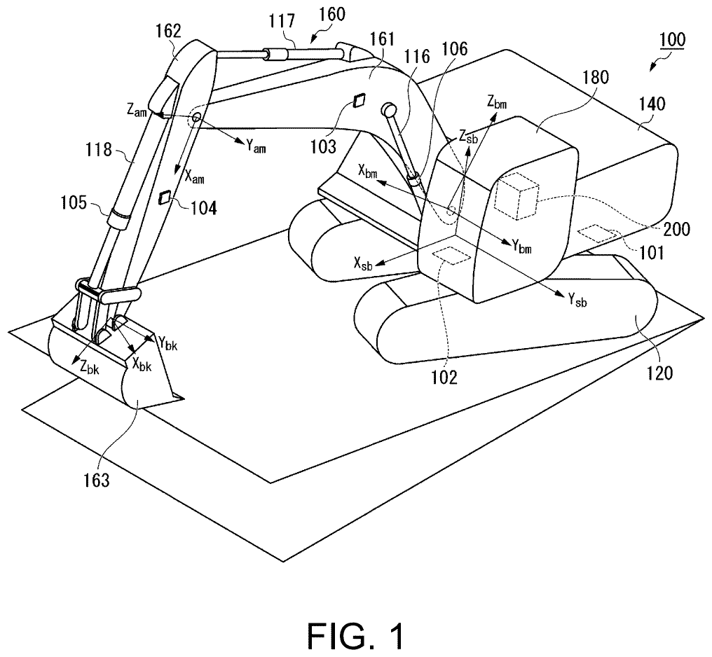

Hereinafter, embodiments will be described in detail with reference to the drawings. FIG. 1 is a schematic diagram illustrating a configuration of a work machine 100 according to a first embodiment. The work machine 100 according to the first embodiment is, for example, a hydraulic excavator. The work machine 100 includes a traveling body 120, a revolving body 140, a work implement 160, a cab 180, and a control device 200. The work machine 100 according to the first embodiment generates a planar virtual wall VW through operation by an operator, and is controlled such that the work machine 100 does not come into contact with the virtual wall VW. This enables the operator to operate the work machine 100 so as not to enter the restricted area.

The traveling body 120 supports the work machine 100 such that the work machine 100 can travel. The traveling body 120 is, for example, a pair of left and right endless tracks.

The revolving body 140 is supported by the traveling body 120 to be capable of revolving about a revolution center.

The work implement 160 is operably supported on the revolving body 140. The work implement 160 is hydraulically driven. The work implement 160 includes a boom 161, an arm 162, and an attachment 163 which is a work tool. The attachment 163 is an example of a work tool. The attachment 163 in the example illustrated in FIG. 1 is a bucket. A base end portion of the boom 161 is rotatably attached to the revolving body 140. A base end portion of the arm 162 is rotatably attached to a tip end portion of the boom 161. The attachment 163 is rotatably attached to a tip end portion of the arm 162. Here, a portion of the revolving body 140 to which the work implement 160 is attached is referred to as a front portion. In addition, with respect to the revolving body 140, with the front portion being taken as the reference portion, a portion on a side opposite thereto is referred to as a rear portion, a portion on the left side is referred to as a left portion, and a portion on the right side is referred to as a right portion.

The cab 180 is provided at the front portion of the revolving body 140. In the cab 180, an operation device 141 for the operator to operate the work machine 100, and a monitor device 142 which is a man-machine interface for the control device 200 are provided. The monitor device 142 is realized by, for example, a computer equipped with a touch panel.

The control device 200 controls the traveling body 120, the revolving body 140, and the work implement 160, based on the operation of the operation device by the operator. The control device 200 is provided, for example, inside the cab 180.

### Drive System of Work Machine 100

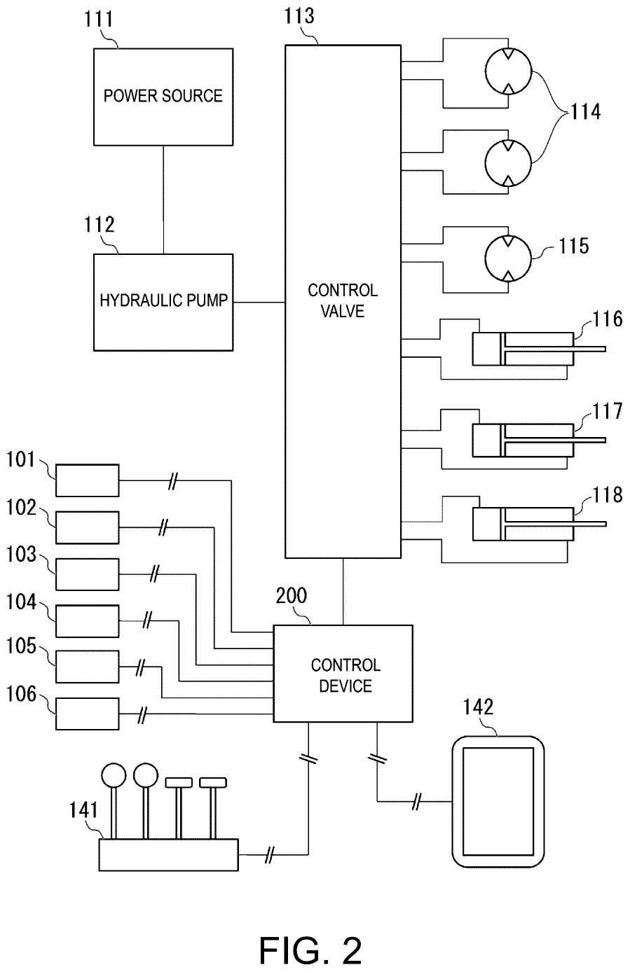

FIG. 2 is a diagram illustrating a drive system of the work machine 100 according to the first embodiment.

The work machine 100 includes a plurality of actuators for driving the work machine 100. Specifically, the work machine 100 includes a power source 111, a hydraulic pump 112, a control valve 113, a pair of travel motors 114, a revolution motor 115, a boom cylinder 116, an arm cylinder 117, and an attachment cylinder 118.

The power source 111 drives the hydraulic pump 112. The power source 111 is, for example, an engine.

The hydraulic pump 112 is driven by the power source 111 and supplies hydraulic oil to the travel motor 114, the revolution motor 115, the boom cylinder 116, the arm cylinder 117, and the attachment cylinder 118 via the control valve 113.

The control valve 113 controls the flow rate of hydraulic oil supplied from the hydraulic pump 112 to the travel motor 114, the revolution motor 115, the boom cylinder 116, the arm cylinder 117, and the attachment cylinder 118.

The travel motor 114 is driven by hydraulic oil supplied from the hydraulic pump 112 to drive the traveling body 120.

The revolution motor 115 is driven by hydraulic oil supplied from the hydraulic pump 112 to revolve the revolving body 140 relative to the traveling body 120.

The boom cylinder 116 is a hydraulic cylinder for driving the boom 161. A base end portion of the boom cylinder 116 is attached to the revolving body 140. A tip end portion of the boom cylinder 116 is attached to the boom 161.

The arm cylinder 117 is a hydraulic cylinder for driving the arm 162. A base end portion of the arm cylinder 117 is attached to the boom 161. A tip end portion of the arm cylinder 117 is attached to the arm 162.

The attachment cylinder 118 is a hydraulic cylinder for driving the attachment 163. A base end portion of the attachment cylinder 118 is attached to the arm 162. A tip end portion of the attachment cylinder 118 is attached to the attachment 163.

### Measurement System of Work Machine 100

The work machine 100 includes a plurality of sensors for measuring the posture and position of the work machine 100. Specifically, the work machine 100 includes an inclination measuring instrument 101, a revolution angle sensor 102, a boom angle sensor 103, an arm angle sensor 104, an attachment angle sensor 105, and a payload meter 106.

The inclination measuring instrument 101 measures the posture of the revolving body 140. The inclination measuring instrument 101 measures the inclination (for example, a roll angle, a pitch angle, and a yaw angle) of the revolving body 140 with respect to a horizontal plane. An example of the inclination measuring instrument 101 is an inertial measurement unit (IMU). In this case, the inclination measuring instrument 101 measures the acceleration and angular velocity of the revolving body 140, and calculates an inclination of the revolving body 140 with respect to the horizontal plane, based on the measurement results. The inclination measuring instrument 101 is installed, for example, below the cab 180. The inclination measuring instrument 101 outputs the posture data of the revolving body 140, which is a measurement value, to the control device 200.

The revolution angle sensor 102 measures a revolution angle of the revolving body 140 relative to the traveling body 120. The measurement value of the revolution angle sensor 102 indicates zero, for example, when the directions of the traveling body 120 and the revolving body 140 coincide with each other. The revolution angle sensor 102 is installed, for example, at the revolution center of the revolving body 140. The revolution angle sensor 102 outputs revolution angle data, which is a measurement value, to the control device 200.

The boom angle sensor 103 measures a boom angle, which is a rotation angle of the boom 161 relative to the revolving body 140. The boom angle sensor 103 may be an IMU attached to the boom 161. In this case, the boom angle sensor 103 measures the boom angle, based on the inclination of the boom 161 with respect to the horizontal plane and the inclination of the revolving body measured by the inclination measuring instrument 101. The measurement value of the boom angle sensor 103 indicates zero when, for example, the direction of a straight line passing through the base end and the tip end of the boom 161 coincides with the front-rear direction of the revolving body 140. Note that the boom angle sensor 103 according to another embodiment may be a stroke sensor attached to the boom cylinder 116. Furthermore, the boom angle sensor 103 according to another embodiment may be a rotation sensor provided on a pin connecting the revolving body 140 and the boom 161. The boom angle sensor 103 outputs boom angle data, which is a measurement value, to the control device 200.

The arm angle sensor 104 measures an arm angle, which is a rotation angle of the arm 162 relative to the boom 161. The arm angle sensor 104 may be an IMU attached to the arm 162. In this case, the arm angle sensor 104 measures the arm angle, based on the inclination of the arm 162 with respect to the horizontal plane and the boom angle measured by the boom angle sensor 103. The measurement value of the arm angle sensor 104 indicates zero, for example, when the direction of a straight line passing through the base end and the tip end of the arm 162 coincides with the direction of a straight line passing through the base end and the tip end of the boom 161. In addition, the arm angle sensor 104 according to another embodiment may be configured such that a stroke sensor is attached to the arm cylinder 117 to calculate the angle. Furthermore, the arm angle sensor 104 according to another embodiment may be a rotation sensor provided on a pin connecting the boom 161 and the arm 162. The arm angle sensor 104 outputs arm angle data, which is a measurement value, to the control device 200.

The attachment angle sensor 105 measures an attachment angle, which is a rotation angle of the attachment 163 relative to the arm 162. The attachment angle sensor 105 may be a stroke sensor provided on the attachment cylinder 118 for driving the attachment 163. In this case, the attachment angle sensor 105 measures the attachment angle, based on the stroke amount of the attachment cylinder 118. The measurement value of the attachment angle sensor 105 indicates zero, for example, when the direction of a straight line passing through the base end and the tip end portion of the attachment 163 coincides with the direction of a straight line passing through the base end and the tip end of the arm 162. Note that the attachment angle sensor 105 according to another embodiment may be a rotation sensor provided on a pin connecting the arm 162 and the attachment 163. In addition, the attachment angle sensor 105 according to another embodiment may be an IMU attached to the attachment 163. The attachment angle sensor 105 outputs attachment angle data, which is a measurement value, to the control device 200.

The payload meter 106 measures a weight of the load held by the attachment 163. The payload meter 106 measures, for example, a bottom pressure of the cylinder of the boom 161 and converts the bottom pressure into the weight of the load. Also for example, the payload meter 106 may be a load cell. The payload meter 106 outputs load weight data, which is a measurement value, to the control device 200.

### Configuration of Control Device 200

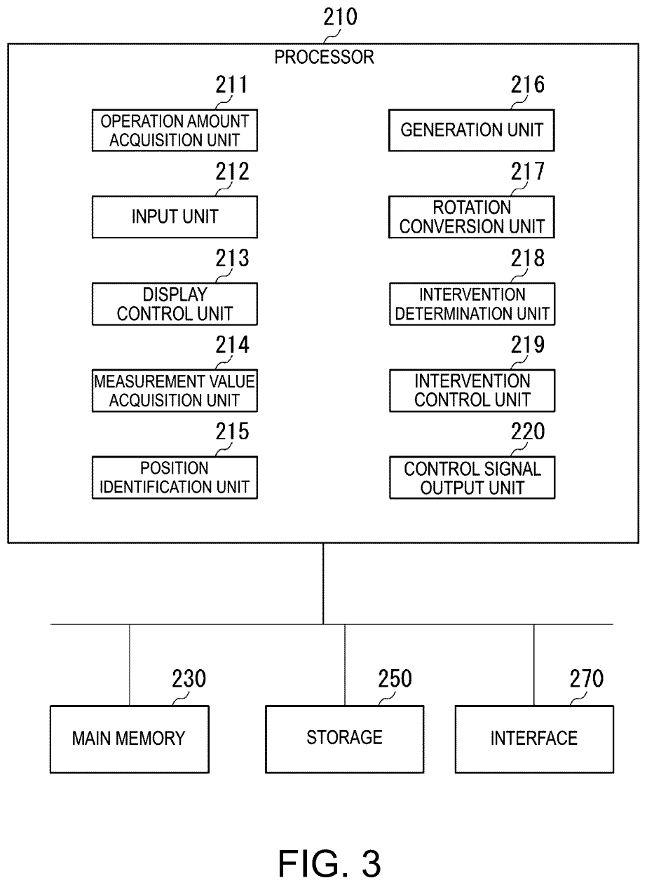

FIG. 3 is a schematic block diagram illustrating a configuration of the control device 200 according to the first embodiment.

The control device 200 is a computer including a processor 210, a main memory 230, a storage 250, and an interface 270. The control device 200 is an example of a control system. The control device 200 receives measurement values from the inclination measuring instrument 101, the revolution angle sensor 102, the boom angle sensor 103, the arm angle sensor 104, the attachment angle sensor 105, and the payload meter 106.

The storage 250 is a non-transitory, tangible storage medium. Examples of the storage 250 include a magnetic disk, an optical disc, a magneto-optical disk, and a semiconductor memory. The storage 250 may be an internal medium directly connected to the bus of the control device 200, or may be an external medium connected to the control device 200 via the interface 270 or a communication line. The storage 250 stores a control program for controlling the work machine 100.

The control program may be a program for realizing a part of the functions to be exhibited by the control device 200. For example, the control program may be a program that exhibits a function in combination with other programs already stored in the storage 250 or in combination with other programs implemented in other devices. In addition, in other embodiments, the control device 200 may include, in addition to or instead of the above configuration, a custom large scale integrated circuit (LSI) such as a programmable logic device (PLD). Examples of the PLD include a programmable array logic (PAL), a generic array logic (GAL), a complex programmable logic device (CPLD), and a field programmable gate array (FPGA). In this case, some or all of the functions realized by the processor may be realized by the integrated circuit.

The storage 250 records geometry data representing the dimensions and the center of gravity positions of the revolving body 140, the boom 161, the arm 162, and the attachment 163. Geometry data is data that represents the position of an object in a predetermined coordinate system. Furthermore, the storage 250 stores, for each model number of the attachment 163, geometry data relating to the attachment 163 of the corresponding model number and the main body weight of the corresponding attachment 163. The main body weight is the weight of the attachment 163 in a state where there is no load.

The storage 250 records a revolution angular velocity table, which is a function indicating the relationship between an allowable revolution angle and a reference angular velocity limit. The allowable revolution angle is the angle at which the revolving body 140 can revolve. The allowable revolution angle is represented by the difference between the stop angle and the revolution angle of the moment measured by the revolution angle sensor 102. The reference angular velocity limit is an angular velocity at which the work machine 100, with a reference work tool attached as the attachment 163 and in a reference posture, can stop without exceeding the stop angle when revolving at the corresponding angular velocity. The reference work tool is the attachment 163 used in the experiment for determining the revolution angular velocity table. The reference work tool may be, for example, the heaviest work tool assumed by the manufacturer of the work machine 100. The reference posture is the posture of the work machine 100 used in the experiment for determining the revolution angular velocity table. The posture of the work machine 100 is determined by the boom angle, the arm angle, and the attachment angle. The reference posture may be, for example, the posture in which the distance from the revolution center to the attachment 163 is the longest. The angular velocity limit table is a function in which the reference angular velocity limit decreases as the allowable revolution angle decreases.

The storage 250 records a correction coefficient table, which is a function indicating the relationship between the inertia ratio and the correction coefficient for the reference angular velocity limit. The inertia ratio is the ratio between the inertia moment of the work machine 100, with a reference work tool attached as the attachment 163 and in a reference posture, and the actual inertia moment of the work machine 100. The correction coefficient is a coefficient for correcting the reference angular velocity limit to the actual angular velocity limit of the work machine 100. The actual angular velocity limit of the work machine 100 is an actual angular velocity at which the work machine 100 can stop without exceeding the stop angle when revolving at the corresponding angular velocity. The correction coefficient table is a function in which the correction coefficient increases as the inertia ratio increases.

### Software Configuration

By executing the control program, the processor 210 includes an operation amount acquisition unit 211, an input unit 212, a display control unit 213, a measurement value acquisition unit 214, a position identification unit 215, a generation unit 216, a rotation conversion unit 217, an intervention determination unit 218, an intervention control unit 219, and a control signal output unit 220.

The operation amount acquisition unit 211 acquires an operation signal indicating an operation amount of each actuator from the operation device 141.

The input unit 212 receives an operation input by an operator via the monitor device 142. In particular, when the attachment 163 is replaced, the input unit 212 receives an input of the model number of the attachment 163. Accordingly, the processor 210 reads the geometry data and the main body weight associated with the corresponding model number from the storage 250.

The display control unit 213 outputs screen data to be displayed on the monitor device 142 to the monitor device 142.

The measurement value acquisition unit 214 acquires measurement values from the inclination measuring instrument 101, the revolution angle sensor 102, the boom angle sensor 103, the arm angle sensor 104, the attachment angle sensor 105, and the payload meter 106.

The position identification unit 215 identifies a position of an outer shell of the work machine 100 in a vehicle body coordinate system. The outer shell of the work machine 100 refers to an outer shape of the work machine 100. The outer shell of the work machine 100 is defined by shapes that form the outer shapes of the revolving body 140 and the work implement 160, for example. Specifically, the position identification unit 215 identifies the positions of a plurality of points on the outer shell of the work machine 100 in the vehicle body coordinate system, based on the various measurement values acquired by the measurement value acquisition unit 214 and the geometry data recorded in the storage 250. The plurality of points on the outer shell identified by the position identification unit 215 include a tip end portion of the attachment 163 (for example, a blade tip of the bucket), an end of the arm 162 on the attachment 163 side (arm top), an end of the arm 162 on the boom 161 side (arm bottom), and a point behind a counterweight of the revolving body 140. The vehicle body coordinate system is an orthogonal coordinate system whose origin is a representative point of the revolving body 140 (for example, a point passing through the revolution center). The calculations of the position identification unit 215 will be described later. Note that the points identified by the position identification unit 215 are not limited thereto.

When the input unit 212 receives an instruction to generate the virtual wall VW from an operator, the generation unit 216 calculates parameters of the virtual wall VW, based on the position of the tip end portion of the attachment 163 identified by the position identification unit 215. The generation unit 216 records the parameters of the generated virtual wall VW in the vehicle body coordinate system in the main memory 230.

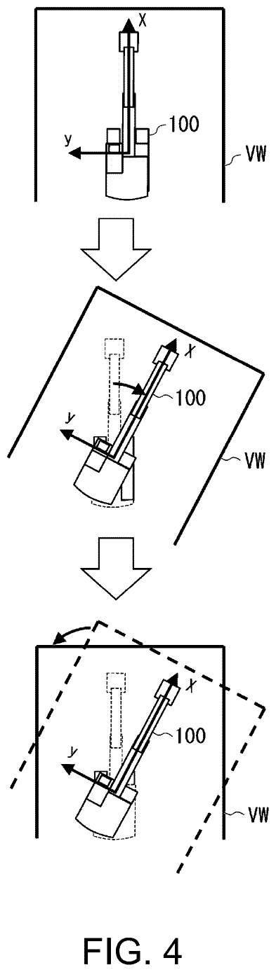

The rotation conversion unit 217 updates the parameters of the virtual wall VW stored in the main memory 230 as the revolving body 140 revolves. Specifically, the rotation conversion unit 217 performs rotation conversion on the parameters of the virtual wall VW around the origin of the vehicle body coordinate system by the amount of change in the pitch angle, the roll angle, and the yaw angle measured by the inclination measuring instrument 101. FIG. 4 is a diagram illustrating an example of resetting the virtual wall VW in association with the revolution of the revolving body in the first embodiment. For example, as illustrated in FIG. 4, when the revolving body 140 revolves after the virtual wall VW is set, the rotation conversion unit 217 calculates the amount of change in the roll angle, the pitch angle, and the yaw angle caused by the revolution of the revolving body 140 by referring to the measurement values of the inclination measuring instrument 101 acquired by the measurement value acquisition unit 214, and performs rotation conversion on the parameters of the virtual wall VW around the origin of the vehicle body coordinate system. This enables the rotation conversion unit 217 to cancel the rotation of the virtual wall VW caused by the revolution of the revolving body 140.

The intervention determination unit 218 determines whether or not to limit the revolution speed of the revolving body 140 or the speed of the work implement 160, based on a positional relationship between the plurality of points of the outer shell identified by the position identification unit 215 and the virtual wall VW. Hereinafter, limiting the speed of the revolving body 140 or the work implement 160 by the control device 200 is also referred to as intervention control. Specifically, the intervention determination unit 218 obtains an allowable revolution angle, which is an angle at which the revolving body 140 can revolve before the virtual wall VW comes into contact with at least one of a plurality of points on the outer shell. The intervention determination unit 218 determines that intervention control is to be performed on the revolving body 140 when the allowable revolution angle is equal to or less than a predetermined angle. In addition, the intervention determination unit 218 obtains a minimum distance between the virtual wall VW and the work implement 160, and when the minimum distance is equal to or less than a predetermined distance, the intervention determination unit 218 determines that intervention control should be performed on the work implement 160.

When the intervention determination unit 218 determines that intervention control is to be performed, the intervention control unit 219 controls the operation amount of the intervention target among the operation amounts acquired by the operation amount acquisition unit 211.

The control signal output unit 220 outputs the operation amount acquired by the operation amount acquisition unit 211 or the operation amount controlled by the intervention determination unit 218 to the control valve 113.

### Calculation of Position Identification Unit 215

Here, a method for identifying the positions of points on the outer shell of the work machine 100 by the position identification unit 215 will be described. The position identification unit 215 identifies the positions of the points on the outer shell, based on the various measurement values acquired by the measurement value acquisition unit 214 and the geometry data recorded in the storage 250. The storage 250 records geometry data representing the dimensions of the revolving body 140, the boom 161, the arm 162, and the attachment 163.

The geometry data of the revolving body 140 indicates the positions (x_{bm}, y_{bm}, z_{bm}) of the pins supporting the boom 161 of the revolving body 140 in the vehicle body coordinate system, which is a local coordinate system, and the positions (xₛₚ, yₛₚ, zₛₚ) of points on the outer shell of the revolving body 140. Examples of points on the outer shell of the revolving body 140 include points that are likely to come into contact with a wall surface when revolving, such as protruding points of a counterweight. The vehicle body coordinate system is a coordinate system that is configured with an X_{sb} axis extending in the front-rear direction, a Y_{sb} axis extending in the left-right direction, and a Z_{sb} axis extending in the up-down direction, with reference to the revolution center of the revolving body 140. The up-down direction of the revolving body 140 does not necessarily coincide with the vertical direction.

The geometry data of the boom 161 indicates the position (xₐₘ, yₐₘ, zₐₘ) of the boom top in a boom coordinate system, which is a local coordinate system. The boom coordinate system is a coordinate system that is configured with an X_{bm} axis extending in the longitudinal direction, a Y_{bm} axis extending in the direction in which the pin extends, and a Z_{bm} axis orthogonal to the x_{bm} axis and the Y_{bm} axis, with reference to the position of the pin connecting the boom 161 and the revolving body 140. The position of the boom top is the position of the pin that connects the boom 161 and the arm 162. The boom top is a point on the outer shell of the work machine 100.

The geometry data of the arm 162 indicates the position (xₐₜ, yₐₜ, zₐₜ) of the arm top in an arm coordinate system, which is a local coordinate system. The arm coordinate system is a coordinate system that is configured with an Xₐₘ axis extending in the longitudinal direction, a Yₐₘ axis extending in the direction in which the pin extends, and a Zₐₘ axis orthogonal to the Xₐₘ axis and the Yₐₘ axis, with reference to the position of the pin connecting the arm 162 and the boom 161. The position of the arm top is the position of the pin that connects the arm 162 and the attachment 163. The arm top is a point on the outer shell of the work machine 100.

The geometry data of the attachment 163 indicates the position (x_{cp}, y_{cp}, z_{cp}) of the tip end portion of the attachment 163 in the attachment coordinate system, which is a local coordinate system. The attachment coordinate system is a coordinate system that is configured with an Xₐₜ axis extending in the direction of the tip end portion, a Yₐₜ axis extending in the direction in which the pin extends, and a Zₐₜ axis orthogonal to the Xₐₜ axis and the Yₐₜ axis, with reference to the position of the pin connecting the attachment 163 and the arm 162.

The position identification unit 215 generates a boom-vehicle body transformation matrix T^{bm}_{sb} for transforming from the boom coordinate system to the vehicle body coordinate system, based on a measurement value of a boom angle θ_{bm} acquired by the measurement value acquisition unit 214 and the geometry data of the revolving body 140, using the following equation (1). The boom-vehicle body transformation matrix T^{bm}_{sb} is a matrix that rotates by the boom angle θ_{bm} around the Y_{bm} axis and translates by the deviation (x_{bm}, y_{bm}, z_{bm}) between the origin of the vehicle body coordinate system and the origin of the boom coordinate system.

In addition, the position identification unit 215 obtains the product of the position of the boom top in the boom coordinate system indicated by the geometry data of the boom 161 and the boom-vehicle body transformation matrix T^{bm}_{sb}, thereby obtaining the position of the boom top in the vehicle body coordinate system.

$$\begin{matrix}[ Math . 1 ] & \\ {T}_{sb}^{bm} = [ \begin{matrix}cos {θ}_{bm} & 0 & sin {θ}_{bm} & {x}_{bm} \\ 0 & 1 & 0 & {y}_{bm} \\ - sin {θ}_{bm} & 0 & cos {θ}_{bm} & {z}_{bm} \\ 0 & 0 & 0 & 1\end{matrix} ] & ( 1 )\end{matrix}$$

The position identification unit 215 generates an arm-boom transformation matrix T^{am}_{bm} for transforming from the arm coordinate system to the boom coordinate system, based on a measurement value of an arm angle θₐₘ acquired by the measurement value acquisition unit 214 and the geometry data of the boom 161, using the following equation (2). The arm-boom transformation matrix T^{am}_{bm} is a matrix that rotates by the arm angle θₐₘ around the Yₐₘ axis and translates by the deviation (xₐₘ, yₐₘ, zₐₘ) between the origin of the boom coordinate system and the origin of the arm coordinate system. In addition, the position identification unit 215 generates an arm-vehicle body transformation matrix T^{am}_{sb} for transforming from the arm coordinate system to the vehicle body coordinate system by obtaining the product of the boom-vehicle body transformation matrix T^{bm}_{sb} and the arm-boom transformation matrix T^{am}_{bm}. In addition, the position identification unit 215 obtains the product of the position of the arm top in the arm coordinate system indicated by the geometry data of the arm 162 and the arm-vehicle body transformation matrix T^{am}_{sb}, thereby obtaining the position of the arm top in the vehicle body coordinate system.

$$\begin{matrix}[ Math . 2 ] & \\ {T}_{bm}^{am} = [ \begin{matrix}cos {θ}_{am} & 0 & sin {θ}_{am} & {x}_{am} \\ 0 & 1 & 0 & {y}_{am} \\ - sin {θ}_{am} & 0 & cos {θ}_{am} & {z}_{am} \\ 0 & 0 & 0 & 1\end{matrix} ] & ( 2 )\end{matrix}$$

The position identification unit 215 generates an attachment-arm transformation matrix T^{at}ₐₘ for transforming from the attachment coordinate system to the arm coordinate system, based on a measurement value of an attachment angle θₐₜ acquired by the measurement value acquisition unit 214 and the geometry data of the arm 162, using the following equation (3). The attachment-arm transformation matrix T^{at}ₐₘ is a matrix that rotates by the attachment angle θₐₜ around the Yₐₜ axis and translates by the deviation (xₐₜ, yₐₜ, zₐₜ) between the origin of the arm coordinate system and the origin of the attachment coordinate system. In addition, the position identification unit 215 generates an attachment-vehicle body transformation matrix T^{at}_{sb} for transforming from the attachment coordinate system to the vehicle body coordinate system by obtaining the product of the arm-vehicle body transformation matrix T^{am}_{sb}, and the attachment-arm transformation matrix T^{at}ₐₘ.

$$\begin{matrix}[ Math . 3 ] & \\ {T}_{am}^{at} = [ \begin{matrix}cos {θ}_{at} & 0 & sin {θ}_{at} & {x}_{at} \\ 0 & 1 & 0 & {y}_{at} \\ - sin {θ}_{at} & 0 & cos {θ}_{at} & {z}_{at} \\ 0 & 0 & 0 & 1\end{matrix} ] & ( 3 )\end{matrix}$$

The position identification unit 215 obtains the product of the position of the tip end portion in the attachment coordinate system indicated by the geometry data of the attachment 163 and the attachment-vehicle body transformation matrix T^{at}_{sb}, thereby obtaining the position of the tip end portion of the attachment 163 in the vehicle body coordinate system.

### Control Method for Work Machine 100

Hereinafter, a control method for the work machine 100 according to the first embodiment will be described.

When the control device 200 is started, the control device 200 reads the geometry data, the angular velocity limit table, and the correction coefficient table recorded in the storage 250 into the main memory 230.

When the operator of the work machine 100 replaces the attachment 163 of the work machine 100, the operator operates the monitor device 142 and sets the attachment 163. When the input unit 212 receives a setting instruction for the attachment 163 from the monitor device 142, the display control unit 213 displays a selection screen for the model number of the attachment 163 recorded in the storage 250. The selection screen includes a list of model numbers of a plurality of attachments 163. The operator operates the monitor device 142 to select one model number. When the input unit 212 receives the selection of the model number of the attachment 163 from the monitor device 142, the input unit 212 records the value of the model number in the main memory 230. The input unit 212 also reads the value of the model number into the storage 250 for reading at the next startup. In addition, the intervention control unit 219 reads the geometry data and the main body weight associated with the read model number from the storage 250 and reads them into the main memory 230.

In addition, the operator of the work machine 100 operates the monitor device 142 to set the virtual wall VW. When the input unit 212 receives an instruction to set a virtual wall VW from the monitor device 142, the display control unit 213 causes the monitor device 142 to display a selection screen for the type of the virtual wall VW to be set. The control device 200 can set five types of virtual walls VW: a front wall, a left wall, a right wall, an upper wall, and a lower wall. The front wall, the left wall, and the right wall are wall surfaces that extend in the vertical direction. The upper wall and the lower wall are wall surfaces that extend in the horizontal direction. The virtual wall VW is represented by a normal vector indicating the normal direction of the virtual wall VW and a position vector indicating the position of a point through which the virtual wall VW passes, both of which are defined in the vehicle body coordinate system.

The work machine 100 can perform work within the reach of the work implement 160 by revolving the revolving body 140. Therefore, typically, the operator revolves the work machine 100 when performing work such as excavation. The vehicle body coordinate system is based on the revolving body 140 and therefore rotates following the revolution of the work machine 100 when viewed from the viewpoint of the global coordinate system. When the virtual wall VW set in the vehicle body coordinate system rotates following the revolution of the work machine 100, the right wall and the left wall do not interfere with the work machine 100 and this is meaningless. For example, when a right wall is set on the right side of the revolving body 140, the right wall is always maintained on the right side of the revolving body 140 regardless of how the revolving body 140 is revolved and does not interfere with the work machine 100. Furthermore, when the front wall rotates following the revolution of the work machine 100, it behaves as an annular wall rather than a planar wall, and therefore does not function as a virtual wall VW along the wall surface of the building. Therefore, the control device 200 according to the first embodiment performs a rotation conversion process of the virtual wall VW in order to maintain the position of the virtual wall VW in the global coordinate system before and after the work machine 100 revolves.

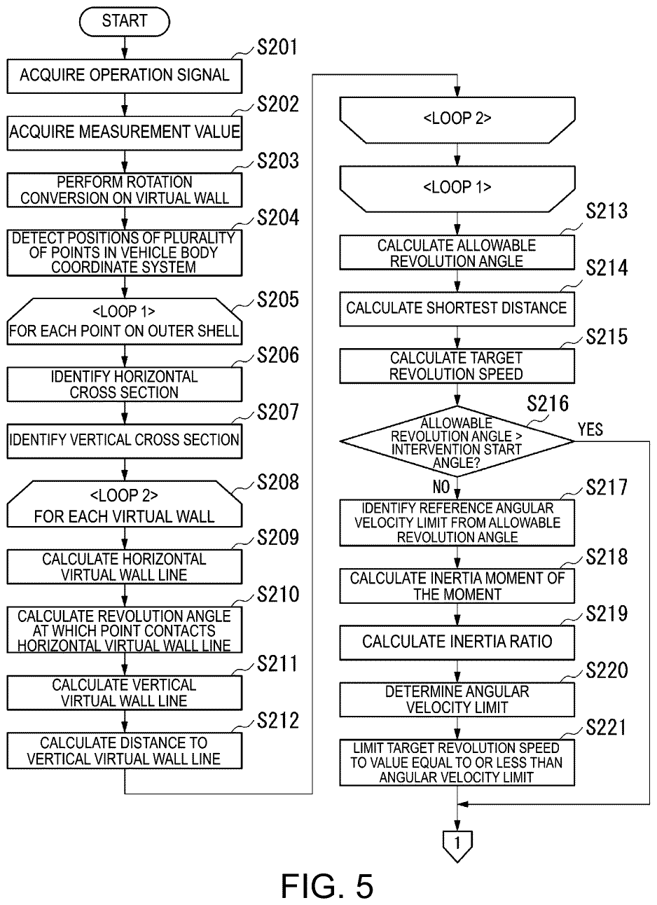

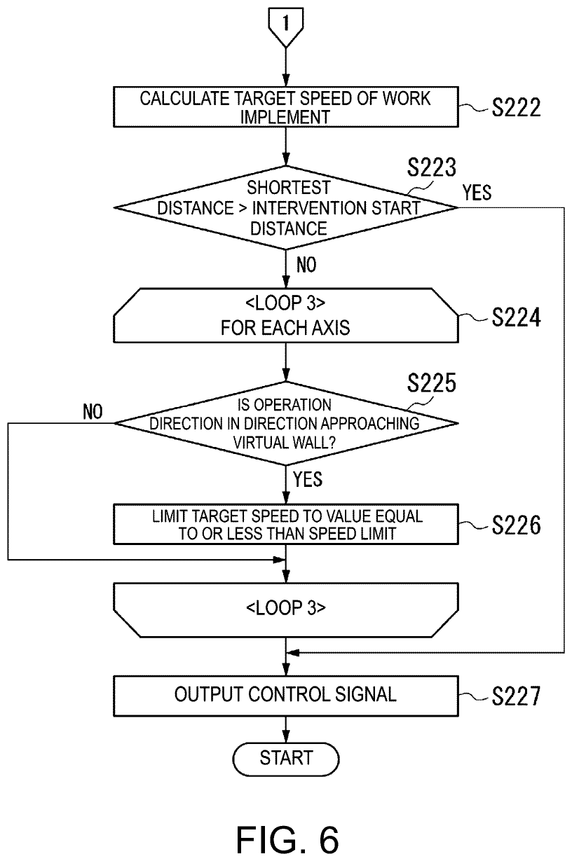

FIG. 5 is a flowchart (part 1) showing update and intervention control of the virtual wall VW set in the first embodiment. FIG. 6 is a flowchart (part 2) showing update and intervention control of the virtual wall VW set in the first embodiment. When the operator of the work machine 100 sets at least one virtual wall VW by operating the monitor device 142, the control device 200 starts the control described below.

The operation amount acquisition unit 211 acquires operation signals of the boom 161, the arm 162, the attachment 163, and the revolving body 140 from the operation device 141 (step S201). The measurement value acquisition unit 214 acquires the measurement values of the inclination measuring instrument 101, the revolution angle sensor 102, the boom angle sensor 103, the arm angle sensor 104, the attachment angle sensor 105, and the payload meter 106 (step S202).

The rotation conversion unit 217 rotationally converts and updates each of one or more virtual walls VW stored in the main memory 230, based on the roll angle, the pitch angle, and the yaw angle of the revolving body 140 acquired from the inclination measuring instrument 101 in step S202 (step S203).

The position identification unit 215 calculates the positions of a plurality of points on the outer shell of the work machine 100 in the vehicle body coordinate system, based on the measurement values acquired in step S202 (step S204). The intervention determination unit 218 selects one by one from points identified by the position identification unit 215 (step S205), and executes the following processes from step S206 to step S212.

The intervention determination unit 218 identifies a cross section that passes through the point selected in step S205 and is parallel to the X_{sb}-Y_{sb} plane of the vehicle body coordinate system (step S206). Furthermore, the intervention determination unit 218 identifies a cross section that passes through the point selected in step S205 and is parallel to the X_{sb}-Z_{sb} plane of the vehicle body coordinate system (step S207).

The intervention determination unit 218 selects one by one from one or more virtual walls VW set in the main memory 230 (step S208), and executes the following processes from step S209 to step S212.

The intervention determination unit 218 calculates an intersection line between the cross section generated in step S206 and the virtual wall VW selected in step S208 as a horizontal virtual wall line (step S209). Depending on the positional relationship between the cross section generated in step S206 and the virtual wall VW, there may be cases where a horizontal virtual wall line does not exist. When a horizontal virtual wall line exists, the intervention determination unit 218 obtains the revolution angle at which the point selected in step S205 contacts the horizontal virtual wall line calculated in step S209 for each of the right revolution and the left revolution (step S210). For example, the intervention determination unit 218 calculates an intersection between a circle centered on the revolution center and passing through the point selected in step S205 and the horizontal virtual wall line, and obtains the angle between the line segment extending from the revolution center to the point selected in step S205 and the line segment extending from the revolution center to the intersection. Depending on the positional relationship between the point selected in step S205 and the horizontal virtual wall line, there may be cases where an intersection does not exist.

In addition, the intervention determination unit 218 calculates an intersection line between the cross section generated in step S207 and the virtual wall VW selected in step S208 as a vertical virtual wall line (step S211). Depending on the positional relationship between the cross section generated in step S207 and the virtual wall VW, there may be cases where a vertical virtual wall line does not exist. When a vertical virtual wall line exists, the intervention determination unit 218 obtains the distance between the point selected in step S205 and the vertical virtual wall line calculated in step S211 (step S212).

The intervention determination unit 218 calculates an allowable revolution angle, which is an angle at which the revolving body 140 can revolve before at least one of the plurality of points comes into contact with at least one virtual wall VW for each of the right revolution and the left revolution, based on the revolution angle for each virtual wall VW at each point on the work machine 100 obtained in step S210 (step S213).

The intervention determination unit 218 calculates the shortest distance between the work implement 160 and the virtual wall VW, based on the distance to each virtual wall VW at each point on the work machine 100 obtained in step S212 (step S214).

The intervention determination unit 218 calculates the revolution direction and the target revolution speed in response to the operation signal of the revolving body 140 acquired in step S201 (step S215). The intervention determination unit 218 determines whether or not the allowable revolution angle in the revolution direction indicated by the operation signal is greater than the intervention start angle (step S216). When the allowable revolution angle is greater than the intervention start angle (step S216: YES), the intervention control unit 219 does not perform intervention control for the revolution. On the other hand, when the allowable revolution angle is equal to or less than the intervention start angle (step S216: NO), the intervention control unit 219 identifies a reference angular velocity limit from the allowable revolution angle, based on the angular velocity limit table (step S217).

Next, the intervention control unit 219 calculates the inertia moment of the work machine 100 of the moment, based on the position of the arm top among the plurality of points identified in step S204 and the main body weight of the attachment 163 being attached at the moment that has been read into the main memory 230 (step S218). The inertia moment is obtained, for example, by the product of the weight of the work implement 160 (the sum of the main body weights of the boom 161, the arm 162 and the attachment 163) and the square of the distance from the revolution center to the arm top. The intervention control unit 219 calculates an inertia ratio by dividing the inertia moment of the moment by the inertia moment associated with the reference work tool and the reference posture (step S219). The inertia moment associated with the reference work tool and the reference posture is obtained in advance by experiment or the like.

The intervention control unit 219 identifies a correction coefficient, based on the correction coefficient table and the inertia ratio, and determines the actual angular velocity limit by multiplying the reference angular velocity limit by the correction coefficient (step S220). The intervention control unit 219 limits the target revolution speed of the revolving body 140 to a value equal to or less than the angular velocity limit (step S221).

The intervention determination unit 218 calculates a target speed of the work implement 160 in response to the operation signals of the boom 161, the arm 162, and the attachment 163 acquired in step S201 (step S222). Specifically, the intervention determination unit 218 calculates target speeds of the boom 161, the arm 162, and the attachment 163 in response to the operation signals of the boom 161, the arm 162, and the attachment 163 acquired in step S201. Next, the intervention determination unit 218 determines whether or not the shortest distance calculated in step S214 is longer than the intervention start distance (step S223). When the shortest distance is longer than the intervention start distance (step S223: YES), the intervention control unit 219 does not perform intervention control for the work implement 160. On the other hand, when the shortest distance is equal to or less than the intervention start distance (step S223: NO), the intervention control unit 219 selects each axis of the work implement 160 one by one, and performs the following processes from steps S225 to S226 for the selected axis (step S224). The intervention control unit 219 determines whether or not the operation direction of the selected axis is an operation in a direction approaching the virtual wall VW (step S225). When the operation direction of the selected axis is not an operation in a direction approaching the virtual wall VW (step S225: NO), the intervention control unit 219 does not perform intervention control for the selected axis. On the other hand, when the operation direction of the selected axis is an operation in a direction approaching the virtual wall VW (step S225: YES), the intervention control unit 219 identifies the speed limit for the selected axis, based on a predetermined speed limit table, and limits the target speed to a value equal to or less than the speed limit (step S226).

The control signal output unit 220 generates a control signal, based on the target speeds of the boom 161, the arm 162, and the attachment 163 and the target angular velocity of the revolving body 140, and outputs the control signal to the control valve 113 (step S227).

### Actions and Effects

In this manner, the control device 200 according to the first embodiment controls the work machine 100 in the following procedure. The control device 200 identifies a virtual wall VW, which is a surface that prohibits the work implement 160 from entering. The control device 200 determines a revolution angular velocity of the work machine 100 such that the virtual wall VW does not come into contact with the work machine 100. At this time, the control device 200 varies the revolution angular velocity, depending on the main body weight of the attachment 163. The main body weight of each attachment 163 is different, and the difference in main body weight is usually larger than the weight of the load held by the attachment 163. With the control device 200 according to the first embodiment, by changing the revolution angular velocity according to the main body weight of the attachment 163, it is possible to limit the operation of the work machine 100 such that it does not enter the virtual wall VW, regardless of the attachment 163 that is attached.

Furthermore, the control device 200 according to the first embodiment identifies the position of the attachment 163 attached to the work machine 100, and identifies the inertia moment of the work machine 100, based on the position and the main body weight. The control device 200 can limit the work machine 100 with high accuracy by determining the revolution angular velocity, based on the inertia moment.

Moreover, the control device 200 according to the first embodiment controls the work machine 100 in the following procedure. The control device 200 identifies the allowable revolution angle until the virtual wall VW comes into contact with the work machine 100, and identifies the reference angular velocity limit from the allowable revolution angle. The control device 200 identifies an inertia ratio, which is the ratio of the inertia moment of the work machine 100 of the moment to the inertia moment of the work machine 100 relating to the reference posture with a reference work tool attached, and determines the revolution angular velocity of the work machine 100 by multiplying the reference angular velocity limit by a correction coefficient corresponding to the inertia ratio. Accordingly, the control device 200 can determine the revolution angular velocities for the plurality of attachments 163 that can be attached, using one function (revolution angular velocity table) that identifies the reference angular velocity limit from the allowable revolution angle. For example, when the weight of a third-party attachment 163 is known, the control device 200 can obtain the angular velocity limit even if the relationship between the allowable revolution angle and the angular velocity limit for the corresponding attachment 163 is not known in advance.

### Other Embodiments

An embodiment has been described above in detail with reference to the drawings, but a specific configuration is not limited to that described above, and various design changes and the like can be made. That is, in other embodiments, the order of the processing described above may be changed as appropriate. Further, some processing may be executed in parallel.

The control device 200 according to the embodiment described above may be constituted by a single computer. The configuration of the control device 200 may be divided into a plurality of computers, and the plurality of computers may cooperate with each other and serve as the control device 200. In this case, some of the computers constituting the control device 200 may be mounted inside the work machine 100, and other computers may be provided outside the work machine 100.

The control device 200 according to the embodiment described above obtains the inertia moment of the work machine 100 according to the model number of the attachment 163, and identifies the angular velocity limit, based on the inertia ratio calculated from the inertia moment, but the present disclosure is not limited thereto. For example, in other embodiments, without being limited thereto, a revolution angular velocity table showing the relationship between the allowable revolution angle and the angular velocity limit for each of the plurality of attachments 163 that can be attached to the storage 250 may be stored, and the angular velocity limit may be identified without obtaining the inertia ratio. Also, for example, in other embodiments, the angular velocity limit may be directly calculated from the inertia moment of the work machine 100 by simulation or the like.

The control device 200 according to the embodiment described above obtains the inertia moment by the product of the weight of the work implement 160 and the square of the distance from the revolution center to the arm top, but the present disclosure is not limited thereto. For example, the control device 200 according to another embodiment may obtain the inertia moment by the product of the weight of the work implement 160 and the square of the distance from the revolution center to the center of gravity of the work implement 160. In this case, the control device 200 obtains the weight of the work implement 160 and the distance from the revolution center to the center of gravity of the work implement 160 from the weights of the boom 161 and the arm 162 that constitute the work implement 160, and the center of gravity positions of the boom 161, the arm 162 and the attachment 163 identified from the geometry data. Specifically, the control device 200 can obtain the center of gravity position of the work implement 160, based on a vector obtained by multiplying the respective center of gravity positions of the boom 161, the arm 162, and the attachment 163 by known weights. Furthermore, the control device 200 according to another embodiment may identify the inertia moment in consideration of the weight of the load loaded on the attachment 163. For example, the control device 200 may identify the weight of the load from the measurement value of the payload meter 106 and calculate the inertia moment using a value obtained by adding the weight of the load to the weight of the attachment 163.

The control device 200 according to the embodiment described above stores the weights of the plurality of attachments 163 that can be attached and identifies the weight from the model number of the attachment 163, but the present disclosure is not limited thereto. For example, the control device 200 according to another embodiment may receive an input of the weight of the attachment 163 directly from the operator, and perform control using the input weight value. Furthermore, the work machine 100 according to another embodiment may include a sensor that measures the weight of the attachment 163, and the control device 200 may identify the weight, based on the measurement value of the sensor.

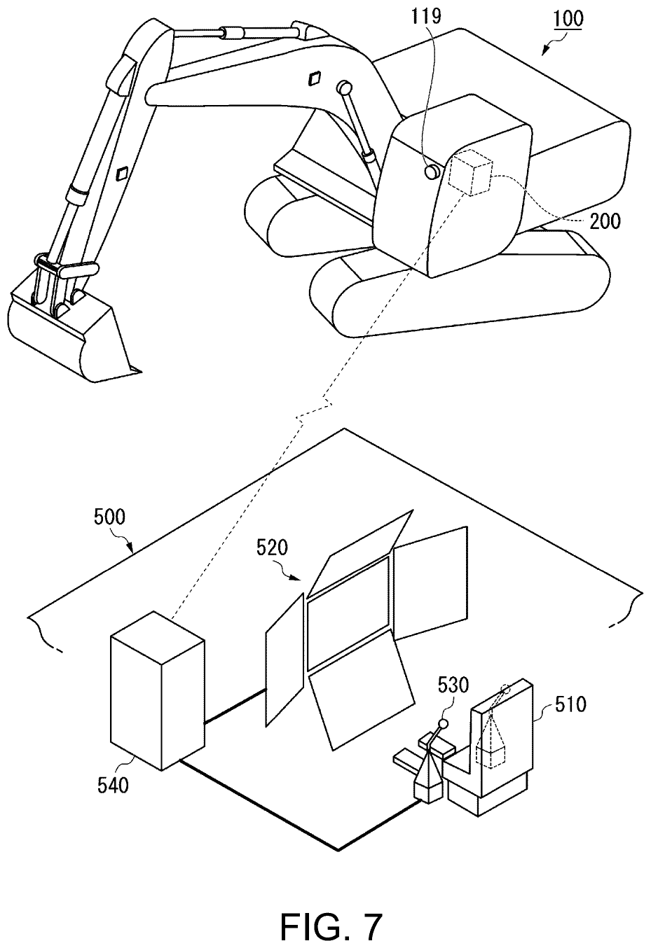

The work machine 100 according to the embodiment described above is operated by an operator who sits in the cab 180, but the work machine 100 according to another embodiment is not limited thereto. FIG. 7 is a diagram illustrating a configuration of a work system according to another embodiment. The work machine 100 according to another embodiment may be operated by a remote operation device 500 as illustrated in FIG. 7. The remotely operated work machine 100 further includes an imaging device 119 in addition to the configuration of the above-described embodiment, and the control device 200 transmits images captured by the imaging device 119 to the remote operation device 500 in real time. The remote operation device 500 includes an operator's seat 510, a display 520, an operation device 530, and a remote operation server 540. The remote operation server 540 causes the image received from the work machine 100 to be displayed on the display 520. Accordingly, the operator can recognize the situation around the remote work machine 100. Furthermore, the remote operation server 540 transmits operation signals from the operator on the operation device 530 to the work machine 100 via the network. The remote operation server 540 executes at least a part of the functions of the control device 200 according to the above embodiment. That is, in a work system including the remote operation server 540, the control device 200 and the remote operation server 540 constitute the work system.

Although a bucket is attached as the attachment 163 to the work implement 160 according to the first embodiment, the present disclosure is not limited thereto. For example, the work implement 160 according to another embodiment may include other work tools, such as a breaker or a grapple, instead of a bucket. Furthermore, the attachment 163 according to another embodiment may be attached to the tip end portion of the arm 162 via a tilt attachment or a tiltrotator attachment.

### REFERENCE SIGNS LIST

100 . . . . Work machine 101 . . . . Inclination measuring instrument 102 . . . . Revolution angle sensor 103 . . . . Boom angle sensor 104 . . . . Arm angle sensor 105 . . . . Attachment angle sensor 106 . . . . Payload meter 111 . . . . Power source 112 . . . . Hydraulic pump 113 . . . . Control valve 114 . . . . Travel motor 115 . . . . Revolution motor 116 . . . . Boom cylinder 117 . . . . Arm cylinder 118 . . . . Attachment cylinder 120 . . . . Traveling body 140 . . . . Revolving body 141 . . . . Operation device 142 . . . . Monitor device 160 . . . . Work implement 161 . . . . Boom 162 . . . . Arm 163 . . . . Attachment 180 . . . . Cab 200 . . . . Control device 210 . . . . Processor 211 . . . . Operation amount acquisition unit 212 . . . . Input unit 213 . . . . Display control unit 214 . . . . Measurement value acquisition unit 215 . . . . Position identification unit 216 . . . . Generation unit 217 . . . . Rotation conversion unit 218 . . . . Intervention determination unit 219 . . . . Intervention control unit 220 . . . . Control signal output unit 230 . . . . Main memory 250 . . . . Storage 270 . . . . Interface VW . . . Virtual wall

1. A system for controlling a work machine including a work implement to which a work tool is attachable at a tip end, the system comprising:
a processor, wherein
the processor is configured to:
identify a virtual wall being a surface that prohibits entry of the work implement;
determine a revolution angular velocity of the work machine such that the virtual wall does not come into contact with the work machine; and
vary the revolution angular velocity, depending on a main body weight of the work tool.

2. The system according to claim 1, wherein
the processor is configured to:
identify a position of the work tool attached to the work machine;
identify an inertia moment of the work machine of the moment, based on the position of the attached work tool and the main body weight; and
determine the revolution angular velocity, based on the inertia moment.

3. The system according to claim 2, wherein
the processor is configured to:
identify an allowable revolution angle until the virtual wall comes into contact with the work machine;
identify, from the allowable revolution angle, a reference angular velocity limit being an angular velocity at which a revolution angle of the work machine relating to a reference posture in which a reference work tool is attached does not exceed the allowable revolution angle;
identify an inertia ratio being a ratio of the inertia moment of the work machine of the moment to the inertia moment of the work machine relating to the reference posture in which the reference work tool is attached; and
determine the revolution angular velocity of the work machine by multiplying the reference angular velocity limit by a coefficient corresponding to the inertia ratio.

4. The system according to claim 1, wherein
the processor is configured to read the main body weight of the work tool attached to the work machine from a storage device configured to store main body weights of a plurality of the work tools attachable to the work implement.

5. A method for controlling a work machine including a work implement to which a work tool is attachable at a tip end, the method comprising:
identifying a virtual wall being a surface that prohibits entry of the work implement; and
determining a revolution angular velocity of the work machine such that the virtual wall does not come into contact with the work machine, wherein
in the determining of the revolution angular velocity, the revolution angular velocity is varied depending on a main body weight of the work tool.

6. A non-transitory computer readable recording medium storing a program executable by a computer configured to control a work machine including a work implement to which a work tool is attachable at a tip end, the program causing the computer to execute:
identifying a virtual wall being a surface that prohibits entry of the work implement; and
determining a revolution angular velocity of the work machine such that the virtual wall does not come into contact with the work machine, wherein
in the determining of the revolution angular velocity, the revolution angular velocity is varied depending on a main body weight of the work tool.
